(19) United States
(12) Patent Application Publication
(10) Pub. No.: US 2009/0067088 A1
(43) Pub. Date: Mar. 12, 2009

(54) RECORDING AND/OR PLAYBACK DEVICE COMPRISING MULTIPLE AZIMUTH MAGNETIC HEADS

(75) Inventors: Jean-Baptiste Albertini, Crolles (FR); Pierre Gaud, Coublevie (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 11/718,458

(22) PCT Filed: Nov. 2, 2005
(86) PCT No.: PCT/FR2005/050920

§ 371 Date: May 2, 2007

(30) Foreign Application Priority Data
Nov. 4, 2004 (FR) 0452528

(51) Int. Cl. G11B 5/265; B44C 1/22

(52) U.S. Cl. 360/121; 216/22; G9B/5.068

(57) ABSTRACT

A device for recording on and/or reading from a magnetic medium with magnetic tracks, including plural magnetic heads each including a pair of polar parts separated by an amagnetic head gap with a given azimuth angle. The pairs of polar parts are distributed on fixed supports, the head gaps of the pairs of polar parts on a particular support all having the same azimuth angle. At least two supports include pairs of polar parts with different azimuth angles, each support having a given tilt angle from the magnetic tracks.

### TECHNICAL DOMAIN

The purpose of this invention is a recording and/or read device with multiple magnetic heads and azimuth-controlled head gaps, and a method of making such a device.

This device with multiple magnetic heads is used in applications for magnetic recording and/or reading of data on any recording medium, either magnetic or magneto-optic, and especially on magnetic tape. The term magnetic medium is used in the remainder of this description to include magnetic media and magneto-optic media. Similarly, when the term magnetic tracks is used, this term should include tracks on a magnetic medium and tracks on a magneto-optic medium.

### STATE OF PRIOR ART

Note that at the moment magnetic tape is the most suitable information medium for compact storage of large quantities of information, typically of the order of a terabyte (1 terabyte=10¹² bytes=8 10¹² bits) or more. Final applications of storage on magnetic tape are typically archiving and backup of computer data and more generally digital data. For example, these data may include data from databases, digitised films, audio and computer files often from computers or digital equipment such as camcorders, VCRs or servers. These data are often called <<multimedia>> and may be used industrially, professionally or by the general public.

Some types of recordings on magnetic media include:

linear recording in which a fixed set of multiple magnetic heads writes and reads several magnetic tracks in parallel on a linearly scrolling magnetic tape,

helical recording in which one or several pairs of magnetic heads installed on a cylindrical drum rotating at high speed, write and read magnetic tracks in the form of portions of spirals on a magnetic tape advancing and winding slowly and sliding around the drum,

magneto-optic recording in which a set of magnetic heads writes magnetic tracks on a magnetic medium, reading being done by a laser beam directly or indirectly detecting magnetisation of previously written bits by a Kerr or Faraday effect.

We will concentrate on linear recording in the following description, although the invention may apply to linear recording, helical recording or magneto-optic recording.

FIG. 1 shows a diagrammatic view of this recording type. A strip 1 of magnetic heads 3 at a spacing of a pitch D is arranged along a generating line on a fixed cylindrical support 2 (drum). Each magnetic head 3 comprises two polar parts 3.1, 3.2 separated by an amagnetic head gap 3.3. In the following, the term head gap for a pair of polar parts, refers to the head gap separating two polar parts in a pair. The magnetic recording medium 4 to be read or recorded moves linearly close to the strip 1. This type of recorder has the advantage that it is mechanically relatively simple (fixed or slightly mobile magnetic heads) and due to its multiple magnetic heads, can carry high speed data flows.

However, it is not optimised in terms of recording density. The fact of having a relatively large pitch D between magnetic heads 3 in the standard configuration due to the size of the magnetic circuit and recording and/or read means makes it necessary:

firstly, to have a <<winding>> recording, in other words a large number of to and from movements to record the entire magnetic medium 4 with tracks 5 at a pitch T′ smaller than the pitch D,

secondly, considering problems with following the track 5 and temperature variations that can arise, to have a large space I between tracks 5, causing loss of space.

Furthermore, tracks 5 recorded in a single pass are at a relatively large distance, consequently simultaneous reading of these tracks 5 at a relatively large spacing is penalised by the mechanical flexibility of the recording magnetic medium 4 that can cause read errors related to poor alignment of bits on these tracks.

U.S. Pat. No. 5,452,165 overcomes some of these difficulties. Refer to FIG. 2. The magnetic heads 13.1, 13.2 are arranged one after the other along the same support 12 (a strip) oriented along a longitudinal axis x′ (called the longitudinal axis of the sequence of magnetic heads) inclined by an angle θ (called the tilt angle) from a longitudinal x axis of the tracks 15 on the magnetic recording medium 14.

The magnetic heads 13.1, 13.2 can simultaneously record and/or read information bits on several adjacent tracks 15 tilted at opposite azimuth angles +α and −α from one magnetic head to the next. These azimuth angles are measured from a normal to the longitudinal axis x′ of the head 13.1 or 13.2. Two successive magnetic heads 13.1, 13.2 each have a head gap 13.a, 13.b offset by +α or −α respectively from the plane perpendicular to the general x′ direction of the magnetic heads. If these azimuth angles are different, they minimize crosstalk between two successive tracks.

This configuration reduces the distance between tracks so as to make them adjacent or practically adjacent.

The distance D between magnetic heads is reduced due to the use of solenoid shaped windings (not shown) as recording and/or read means. The solenoid-shaped windings reduce the inter-track distance compared with conventional plane windings.

Although this approach is satisfactory, this structure does introduce major disadvantages. The fact of having opposite azimuth angles +α and −α on one strip 12 and a given tilt angle θ results for example in that identical track widths 15 are never obtained on adjacent tracks and therefore there are always different values of electrical signals on these tracks. Information bits written on these tracks have a final azimuth angle measured from a normal to the track that depends on the tilt and azimuth angles of the pairs of polar parts.

The width of the track 15 that cooperates with the magnetic head 13.1 is denoted T1, and the width of the track 15 that cooperates with the magnetic head 13.2 is denoted T2.

We have T1=P cos(α−θ)/cos(α)

and T2=P cos(α+θ)/cos(α) and therefore T1≠T2 in the general case, where P represents the width of polar parts of each magnetic head. It is assumed that the width of the polar parts of all magnetic heads is the same.

Another problem is that industrial production of such magnetic heads is very difficult. The magnetic heads in a particular strip are made simultaneously. The azimuth angle must be made with very high precision. For example for the new so-called DVC (Digital Video Cassette) standard, the azimuth angle is 20 degrees (absolute value) plus or minus 0.15°. It is very difficult to make these opposite azimuth angles with such precision in batch production. It is also difficult to achieve good control over the length of the head gap and the width of polar parts, from one magnetic head to another.

The major problem with this structure is that it gives few degrees of freedom on the parameters: azimuth angle α and width of polar parts P. The width of written tracks is given by the formulas mentioned above. However, it is impossible to adapt to standards for which for example track widths are equal or for which azimuth angles are incompatible with the deposition technique described in U.S. Pat. No. 5,452,165. The slope of the head gap is not easily controllable.

Patent application FR-A-2 774 797 also divulges a recording and/or read device with multiple azimuth-controlled magnetic heads. This device comprises several assembled supports on which magnetic heads are distributed. This device does not allow the supports to have a tilt angle from the tracks. Therefore, it cannot be used to make <<massively parallel>> magnetic heads since manufacturing of magnetic heads to read or write n tracks requires n assembled supports which in practice limits n to 2, 3 or 4 for efficiency reasons. Constraints during assembly lead to weakening of the recording and/or read device.

Furthermore, this device does not include any magnetic heads cooperating with overlapping tracks, as is done at the moment in the industry, because the distance normal to the supports between two pairs of polar parts belonging to two consecutive supports is greater than or equal to zero. This configuration does not allow the recording and/or read device to adapt to a variety of recording standards.

### PRESENTATION OF THE INVENTION

The main objective of this patent is to solve the problems that are not solved by the U.S. Pat. No. 5,452,165 and patent FR-A-2 774 797.

propose a solution for making ‘massively parallel’ magnetic heads adapted to a variety of recording standards: adjustable azimuth angle, track width, inter-track width. In particular, this device can be used to make tracks with the same width, adjacent, practically adjacent or indented;

provide a highly efficient realistic industrial production method, giving greater precision in azimuth angles, with a more competitive cost for multiple heads when there are more than two heads.

Since in prior art the track width can never be constant, the approach adopted with this patent (unlike U.S. Pat. No. 5,452,165) to solve the track width problem is to place the magnetic heads one behind the other and to distribute their pairs of polar parts separated by the head gap on several supports, the head gaps of the pairs of polar parts on a particular support having the same azimuth angle, the pairs of polar parts on a particular support having the same thickness, each support making a given tilt angle with the magnetic tracks.

More precisely, this invention relates to a device for recording and/or reading a magnetic medium with magnetic tracks, comprising several magnetic heads each comprising a pair of polar parts separated by an amagnetic head gap with a given azimuth angle. The pairs of polar parts are distributed on several fixed supports, the head gaps of the pairs of polar parts on a particular support all having the same azimuth angle.

Thus, two supports and an assembly are sufficient to obtain a practically unlimited number of magnetic heads, with n magnetic heads on each support, and the result is a device with 2n magnetic heads.

At least two supports comprise pairs of polar parts for which the head gaps are at different azimuth angles, each support having a given tilt angle from the magnetic tracks.

It is advantageous if all pairs of polar parts located on a particular support have the same width.

Tilt angles on at least two supports, for example two consecutive supports, may be equal or different.

When they are parallel, consecutive supports define an inter polar-part distance that is the distance between planes of faces facing polar parts located on consecutive supports.

A magnetic shielding and/or magneto-resistive read means may be placed in a space corresponding to the inter polar-part distance.

When the tilt angle θ is the same for two consecutive supports, in other words when the supports are parallel, the inter polar-part distance is given by d=[ tan(θ)·(T+D)]−(P1+P2) where θ is the tilt angle of supports relative to the tracks, T is the longitudinal pitch of head gaps of pairs of polar parts located on a particular support, D is the longitudinal offset from supports between two pairs of consecutive polar parts placed on two consecutive supports, P1 is the width of pairs of polar parts on a first support, P2 is the width of polar parts on a second support consecutive to the first support.

Two pairs of polar parts belonging to different supports, for example consecutive supports, can cooperate with two consecutive magnetic tracks to read them or to record them.

If the widths of magnetic medium tracks are to be equal, the following relation must be satisfied: P1·cos(α1−θ)/cos(α1)=P2·cos(α2+θ)/cos(α2), where P1 is the width of pairs of polar parts on a first support, α1 is the azimuth angle of the head gaps of pairs of polar parts on this first support, P2 is the width of pairs of polar parts on a second support, α2 is the azimuth angle of head gaps of pairs of polar supports on this second support, θ is the tilt angle of supports relative to magnetic tracks.

One advantageous choice for azimuth angles is that α1=α2+2θ. The result is writing on two consecutive magnetic tracks with opposite azimuth angles. This is the case for most classical standards such as the DVC standard (+/−20°).

Another advantageous choice is that α1=−α2=α as an absolute value. Supports with the same crystallographic orientation can be used for manufacturing magnetic heads. Rotation of the support by 180° in its plane enables etching with an angle −α if the first etched angle was +α. Then all that is necessary is to choose the width P2=P1·cos(α−θ)/cos (α+θ) to obtain the same width of magnetic recording tracks.

Two consecutive supports can form a common support on which two series of pairs of polar parts are placed on each side of an electrically insulating layer in the common support. For example, an SOI (Silicon On Insulator) type substrate can be used as a common support.

The pairs of polar parts of a support may be pairs of magnetic read or record heads.

The recording and/or read device may comprise at least one block of supports for recording and at least one block of supports for reading, these blocks being arranged one after the other in the direction of the magnetic tracks.

As a variant, it may comprise at least one block of one or several supports for recording and at least one block of one or several supports for reading, the supports of these blocks being fixed to each other.

To prevent crosstalk problems, a block for reading may be separated from a block for recording by a shielding screen.

It will be possible for supports of one block for reading to be alternated with supports of one block for recording. It is then easy to align the head gaps used for reading and for recording.

The magnetic shielding and/or magneto-resistive read means may be contained in an inter-support layer placed in the space corresponding to the inter-polar part distance, this inter-support layer separating a read block support from a record block support.

For each magnetic head, the recording and/or read head comprises a magnetic circuit integrating a pair of polar parts and possibly a magnetic flux guide, this magnetic circuit cooperating with recording and/or read means. In this context, a magnetic flux guide may comprise several parts: the core of a solenoid winding, pads, a rear magnetic part, and a magneto-resistive sensor flux guide.

The recording and/or read means may be inductive or magneto-resistive.

Signal processing means may cooperate with the record and/or read means.

This invention also relates to a method for making a record and/or read device on a magnetic medium with magnetic tracks. It comprises the following steps:

on a first substrate, manufacturing of several first pairs of polar parts of first magnetic heads, these polar parts being separated by an amagnetic head gap with a particular first azimuth angle;

on a second substrate, manufacturing of several second pairs of polar parts of second magnetic heads, these polar parts being separated by an amagnetic head gap with a particular second azimuth angle;

assembly of the first substrate to the second substrate, positioning them such that the first azimuth angle and the second azimuth angle are different after assembly;

manufacturing of recording and/or read means and possibly magnetic flux guides capable of each cooperating with a pair of polar parts of the first pairs of polar parts and/or second pairs of polar parts;

treatment of substrates to provide them with a given tilt angle relative to the magnetic tracks.

The first and the second substrates may be assembled before or after the treatment.

A layer of an electrically insulating material could be inserted between the two substrates.

Shims made from an electrically insulating material could be inserted between the two substrates.

The recording and/or read means and magnetic flux guides, if any, could be made on at least a third substrate that is positioned and assembled with the first substrate and/or the second substrate. A step could be provided to reduce the thickness of at least one of the substrates before assembly.

The first substrate can be assembled to a first third substrate after turning one of the two over, the second substrate is assembled to another third substrate after turning one of the two over, the first substrate is assembled to the second substrate. A step to reduce the thickness of at least one of the substrates may be provided before assembly. A step to insert shims and/or an inter-polar part layer could also be provided.

As a variant, the recording and/or read means and magnetic flux guides, if any, can be made on either the first or the second substrate or both. This could be done before or after their assembly.

The treatment may consist of grinding the substrates before or after assembly or assembling the substrates or one or several parts of the substrates in a particular mechanical support that tilts the substrates.

The tilt angle of the first substrate may be different from the tilt angle of the second substrate.

The method may comprise a step consisting of making pairs of magnetic connection pads in the second substrate that will be used to magnetically connect each of the recording and/or read means or a flux guide to a pair of polar parts in the first substrate.

When there are two third substrates, the pairs of polar parts in the first substrate are coupled to recording and/or read means or a flux guide in one of the third substrates, the pairs of polar parts in the second substrate are coupled to recording and/or read means or a flux guide in the other third substrate.

The first and second substrates may be assembled to each other after turning one of the two over.

A step may be included to thin at least one of the substrates before and/or after assembly.

Positioning is done with alignment of the substrates.

One way of obtaining a first or second pair of polar parts would be to make a first caisson by anisotropic etching in the first or the second substrate, forming an amagnetic layer on the first or the second substrate, the first caisson can be filled with a magnetic material and a second caisson adjacent to the first caisson can be made by isotropic etching, and the second caisson can be filled with a magnetic material.

This amagnetic layer coats the sides of the first caissons with an approximately uniform thickness. The amagnetic material may advantageously be formed by surface oxidation of the first or the second substrate.

A pair of magnetic pads can be obtained by isotropically etching a pair of caissons in the second substrate between two pairs of polar parts in the second substrate, and the pair of caissons can be filled with a magnetic material.

The surface may be leveled after any one of the magnetic material filling steps has been done.

The first substrate and/or the second substrate may be formed from an electrically insulating material located between two layers, one of the layers comprising the caissons being monocrystalline, the other possibly being eliminated later.

As a variant, the first substrate and/or the second substrate may be formed from a layer of electrically insulating material located between the layer of wear resistant material and the layer of monocrystalline material comprising the caissons.

The assembly may be made by gluing, by direct bonding, by anodic assembly or by fusible bumps.

The third substrate within which the recording and/or read means and the magnetic flux guides if any are located, may possibly be multi-layer with a layer of electrically insulating material.

As a variant, the third substrate within which the recording and/or read means are located, and the magnetic flux guides if any, may include a layer made from a wear resistant material possibly covered by an electrically insulating material.

Furthermore, the method comprises a step to make signal processing means (for example preamplifiers, multiplexers, demultiplexers) that cooperate with the recording and/or read means.

### BRIEF DESCRIPTION OF THE FIGURES

This invention will be better understood after reading the description of example embodiments given purely for information and that is in no way limitative, with reference to the appended figures, wherein:

FIG. 1 (already described) shows a linear recording and/or read device according to prior art;

FIG. 2 (already described) shows a recording and/or read device like that shown in patent U.S. Pat. No. 5,452,165;

FIGS. 3 to 7 show several variants of a recording and/or read device according to the invention;

FIGS. 8A, 8B show a side view and a view in space of a recording and/or read device, for which the manufacturing method will be described later;

FIGS. 9A to 9D illustrate steps in manufacturing of first pairs of polar parts of a recording and/or read device according to the invention, on a first substrate;

FIGS. 10A, 10B illustrate steps in manufacturing of second pairs of polar parts of a recording and/or read device according to the invention, and pairs of magnetic connection pads and rear magnetic parts, on a second substrates;

FIGS. 10C and 10D illustrate the assembly of the first and the second substrate;

FIGS. 11A to 11E illustrate steps in manufacturing magnetic circuits (in part) and recording means and/or read means of a recording and/or read device according to the invention on the third substrate, FIG. 11E being a side sectional view of FIG. 11D;

FIGS. 12A and 12B illustrate steps in assembly of the third substrate to the structure in FIG. 10D;

FIG. 13 illustrates grouping of two groups of magnetic heads on the same mechanical support, these groups of magnetic heads having the same tilt angle from the tracks on the magnetic recording medium.

FIGS. 14A to 14H illustrate steps in manufacturing a variant of a recording and/or read device according to the invention in which a 180° flip about both axes was done during the assembly;

FIGS. 15A and 15B illustrate steps in manufacturing another variant of a recording and/or read device according to the invention;

FIG. 16 shows a view in space of a variant of a read device according to the invention in which the read means are formed of magneto-resistive bars;

FIGS. 17A and 17B illustrate steps in manufacturing the read device shown in FIG. 16,

FIG. 17C illustrating another variant of a read device according to the invention;

FIG. 18 shows two substrates carrying pairs of polar parts just before being assembled by fusible balls which enables precise alignment of the substrates.

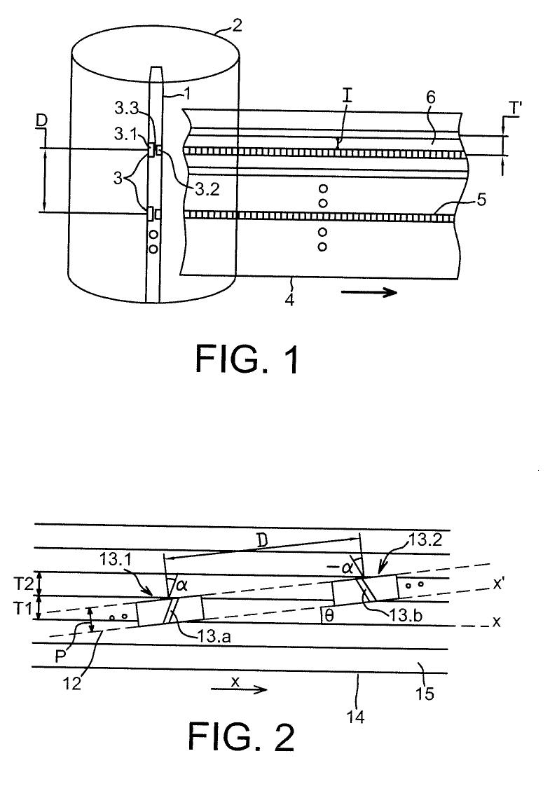

Identical, similar or equivalent parts of the different figures have the same numerical references so as to facilitate the transfer from one figure to the next.

The different parts shown in the figures are not necessarily all at the same scale, to make the figures more easily understandable.

### DETAILED PRESENTATION OF PARTICULAR EMBODIMENTS

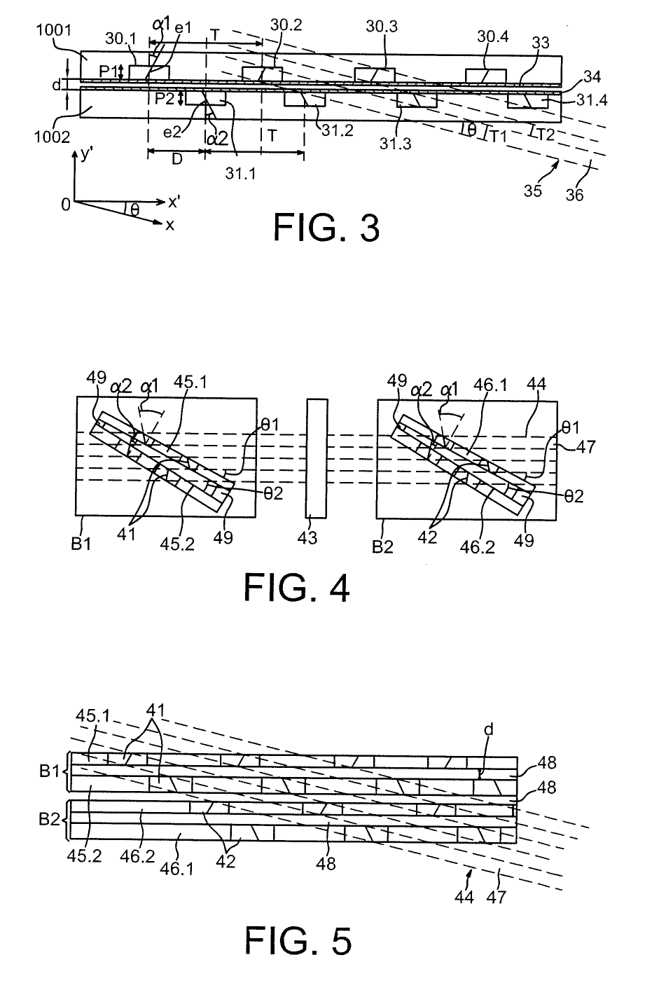

We will now describe a device with magnetic heads according to the invention with reference to FIG. 3.

This device will be used for recording and/or reading information on magnetic tracks carried by a magnetic medium. This magnetic medium is shown as a tape, but other forms are possible, for example a disk. The example that will just been described is applicable to a linear magnetic or magneto-optic recording, but such a recording and/or read device could be used in the framework of a helical recording.

Remember that a magnetic head conventionally comprises amagnetic circuit closing the magnetic flux terminating on a pair of polar parts separated by an amagnetic head gap. This magnetic circuit may include the pairs of polar parts and also a magnetic flux guide. In some configurations, the magnetic flux guide is missing and the shape of pairs of polar parts is appropriate to achieve this magnetic flux guide function.

Recording and/or read means cooperate with the magnetic circuit, possibly consisting of at least one winding that surrounds the magnetic flux guide if there is one, for the inductive recording and/or read heads or a magnetoresistance for the magnetic read heads. This magnetoresistance may be inserted in the flux guide at a head gap on the flux guide, and it may advantageously be in the form of a rod made from a material with Giant Magnetoresistance (GMR) or tunnel effect magnetoresistance TMR properties. If there is no flux guide, the magnetoresistance cooperates directly with a pair of polar parts.

The device according to the invention comprises several magnetic heads 30.1 to 30.4, 31.1 to 31.4 that are each materialised by a pair of polar parts separated by an amagnetic head gap e1, e2. The device also comprises several fixed supports 1001, 1002 and pairs of polar parts of magnetic heads are distributed one after the other on these supports 1001, 1002. The device also comprises at least one inter-support layer 33, 34 between two supports 1001, 1002 that separates levels of pairs of polar parts by a well-adjusted distance d. This distance d separates face planes facing polar parts located on consecutive supports. It is normal to these supports. In the example, there are only two supports 1001, 1002 and they are parallel, first pairs of polar parts of magnetic heads 30.1 to 30.4 are supported by the first support 1001 and second pairs of polar parts of magnetic heads 31.1 to 31.4 are supported by the second support 1002. Obviously, it will be possible to consider using more than two supports assembled after alignment between the inter-support layers 33, 34. If there are more than two supports, one of the first two supports could be thinned before the third support is assembled as will be seen later.

The supports 1001, 1002 are approximately plane, the pairs of polar parts 30.1 to 30.4, 31.1 to 31.4 of the magnetic heads supported on a main face of the corresponding support that is approximately plane. In the example, the pairs of polar parts of magnetic heads are placed on two faces facing the supports. Other configurations are possible.

Magnetic heads are azimuth controlled, this means that each head gap e1, e2 has a given azimuth angle with respect to a perpendicular to the main face of the support 1001, 1002. The pairs of polar parts 30.1 to 30.4 or 31.1 to 31.4 placed on a particular support 1001, 1002 all have the same azimuth angle. This azimuth angle is reference α1 for pairs of polar parts of the support 1001 and α2 for pairs of polar parts of the support 1002. This azimuth angle is between +90° and −90° from a normal to the support, excluding limits.

For each pair of polar parts, a magnetic flux guide and/or a magneto-resistive element (not visible in FIG. 3 but visible in FIG. 16) may be supported on a main face of a support 1001 or 1002, bearing on the pair of polar parts concerned. In the recording and/or read device according to the invention, support assemblies will be cut to show the functional faces of the polar parts, in other words faces perpendicular to the main faces of initial supports that come into contact with the magnetic recording medium.

Each magnetic head is designed to cooperate with a magnetic recording medium 35 oriented approximately parallel to the functional faces of the polar parts and therefore approximately perpendicular to the main face of the support 1001, 1002.

This magnetic medium 35 comprises a large number of magnetic recording tracks 36 on which the magnetic heads are designed to write or to read information. These tracks 36 are created by magnetic recording heads. In the example shown in FIG. 3, tracks 36 have a tilt angle θ from the main surface of the supports 1001, 1002 or with respect to the length of the magnetic heads. In other words, the supports 1001, 1002 have the same tilt angle θ with respect to the general direction of the magnetic recording tracks 36. Therefore the edges of the supports are not parallel to the direction of the tracks 36. The tilt angle θ is not zero and is between ±90°.

Obviously, it would be possible for at least two consecutive supports to have different tilt angles as shown in FIG. 4.

In general, let P1 be the width of all polar parts 30.1 to 30.4 located on the first support 1001. This width is measured perpendicular to the main face of the support 1001 on which the inter-support layer 33 is located.

Let P2 be the width of all polar parts 31.1 to 31.4 located on the second support 1002. This width P2 is measured perpendicular to the main face of the support 1002 on which the inter-support layer 34 is located.

The polar parts located on the same support are all the same width.

Let d be the inter-polar part distance, this distance d is the distance between planes of faces facing pairs of polar parts located on consecutive supports. This distance is not zero. This distance d gives another degree of freedom to adjust the inter-track distance or even to overlap recorded tracks.

Let D be the longitudinal offset from the supports between two consecutive pairs of polar parts 30.1, 31.1 located on consecutive supports 1001, 1002. This longitudinal offset is defined between abscissas of centres of head gaps along the ox′ axis. Let P1, P2 be the widths of polar parts of a support, measured along the oy′ axis.

It is assumed that the head gaps e1, e2 of pairs of polar parts 30.1 to 30.4, 31.1 to 31.4 of magnetic heads are distributed uniformly on the supports 1001, 1002 with the same longitudinal pitch T measured along the ox′ axis. These supports 1001, 1002 have the same tilt angle θ measured from the general direction of the tracks. The tilt angle θ may for example be obtained using mechanical machining of the supports.

To obtain a configuration with adjacent tracks, which is an advantageous special case for compact storage, the following value is assigned the tilt angle:

tan(θ)=(P1+P2+d)/(T+D)

The value of the inter-polar part distance d is given as follows:

d=[ tan(θ)·(T+D)]−(P1+P2)

The inter-polar part distance d is useful particularly for adjusting the longitudinal offset D to a value capable of satisfying a standard (positioning of tracks cooperating with a support relative to the adjacent support) and enabling easy technological manufacturing by optimising the compactness of magnetic heads of two consecutive supports. The magnetic circuit and read and/or recording means adapting to pairs of polar parts impose geometric constraints.

Let T1 be the width of tracks 36 that cooperate with pairs of polar parts 30.1 to 30.4 located on the first support 1001 and let T2 be the width of tracks 36 that cooperate with the pairs of polar parts 31.1 to 31.4 located on the second support 1002. The width of tracks is measured perpendicular to the ox axis.

Geometrically, the widths of the tracks are such that:

T1=P1·cos(α1−θ)/cos(α1)

T2=P2·cos(α2+θ)/cos(α2)

With this new arrangement, it is easy to arrange matter such that T1=T2 due to the infinity of choice of values of width P1 of polar parts of magnetic heads on the first support, of width P2 of polar parts on the second support, of the values of the azimuth angles α1, α2.

Two configurations are particularly interesting. In the first configuration, it may be decided to have final azimuth angles on tracks equal in modulus and opposite in sign, which means that α1−θ=α2+θ, namely α1=α2+2θ. If it is also required that T1=T2, we can choose:

P2=P1·cos(α2)/cos(α2+2θ)

In the second configuration, it would be possible for the azimuth angles to be equal on supports but opposite α1=−α2=α in absolute value. P1 and P2 are chosen to be related by the following relation:

P2=P1·cos(α−θ)/cos(α+θ).

With these choices, T1=T2.

Thus, tracks 36 may be adjacent and may have the same width. Obviously, it is not compulsory to have adjacent tracks or even same width tracks in all cases. The purpose of the invention is to enable manufacturing of magnetic heads that can be adapted to different standards. Thus, the invention can be used to make magnetic heads cooperating with non-adjacent tracks and/or tracks with different widths.

Adjacent tracks 36 (with no inter-track distance) can give the maximum recording density. In this case, the following parameters are related to satisfy:

tan(θ)·(T+D)=P1+P2+d

But if an inter-track distance needs to be introduced for any reason whatsoever, for example to respect a standard, it simply needs to be taken into account in positioning of the magnetic heads and in sizing of the different elements making up the recording and/or read device.

The supports 1001, 1002 may be physically separate and may then be assembled by stacking them, or they may be coincident, for example as in FIG. 7. in this case, the support is a multilayer, it may for example be an SOI (semiconductor on insulator) type substrate or more generally an XOI type substrate where X represents a monocrystalline material. The polar parts are located on each side of the insulating layer. The external layers of the common support are treated like two supports assembled to each other.

When it is required to make a recording and/or read device, it is preferable to dissociate the magnetic heads dedicated to recording from the magnetic heads dedicated to reading, for performance reasons. Magnetic heads dedicated to reading are preferably chosen from among the magnetoresistance MR, giant magnetoresistance GMR and tunnel magnetoresistance TMR types, while magnetic write heads are preferably magnetic inductive heads.

Refer to FIG. 4.

The recording and/or read device may comprise a first block B1 comprising magnetic recording heads 41 and a second block B2 comprising magnetic read heads 42, these two blocks B1, B2 being placed one after the other along the axial direction of the tracks 47 of the magnetic recording medium 44 and being separated in this example by a magnetic shielding screen 43. One of the blocks (for example B1) is dedicated to writing information on the magnetic recording medium 44 and the other (for example B2) is dedicated to reading written information.

Each of these blocks B1, B2 comprises several supports 45.1, 45.2, 46.1, 46.2 respectively on which a sequence of pairs of polar parts is arranged separated by an amagnetic head gap, each head gap materialising a magnetic head 41, 42 shown on the figure. The result after assembly of the blocks and the shielding screen is thus a recording and read device referred to as an RWW (Read While Write) device. Such a device is very attractive because the integrity of recorded data can be checked while writing.

FIG. 4 is intended to show that not all supports necessarily have the same tilt angle from the magnetic tracks 47. The tilt angle of the support 45.1 is denoted θ1 and the tilt angle of the support 45.2 is denoted θ2. It also shows that a distance d between polar parts can be fixed by electrically insulating shims 49. The distance d in this special case is not constant.

Refer to FIG. 5. Instead of the write block B1 and the read block B2 being one after the other along the axial direction of the tracks 47 of the magnetic recording medium 44, they are stacked. A write block B1 formed of several adjacent superposed supports 45.1, 45.2 can be combined with a read block B2 also formed of several adjacent superposed supports 46.1, 46.2. Thus, the two blocks B1, B2 are superposed. The supports 45.1, 45.2 of the write block B1 carry pairs of polar parts of magnetic write heads 41 and the supports 46.1, 46.2 of the read block B2 carry pairs of polar parts of magnetic read heads 42. In FIG. 5, the record and read device is a WWRR (W for write and R for read) device.

In this embodiment, the azimuth angles of the magnetic heads 41, 42 of a block B5, B2 are identical from one block to the next to cooperate. They are different from one support to the next in a particular block.

Magnetic heads 41 or 42 belonging to the same block B5 or B2 have their pairs of polar parts placed on adjacent supports 45.1, 45.2 or 46.1, 46.2. On the example in FIG. 5, it can be seen that in a particular block, the magnetic heads for which pairs of polar parts are carried by a first support have a first azimuth angle and the magnetic heads for which pairs of polar parts are carried by another support have another azimuth angle different from the first azimuth angle.

In this case, the different supports 45.1, 45.2, 46.1, 46.2 are all separated from each other by an inter-support layer 48 with a thickness d that mechanically holds the supports at a precise distance from each other.

In the case in FIG. 5 on which the supports 45.1, 45.2 and 46.1, 46.2 are distributed in two distinct recording and read blocks B1, B2, the inter-support separation layer 48 between the blocks B1, B2 may advantageously comprise magnetic shielding to reduce crosstalk and/or magneto-resistive read means.

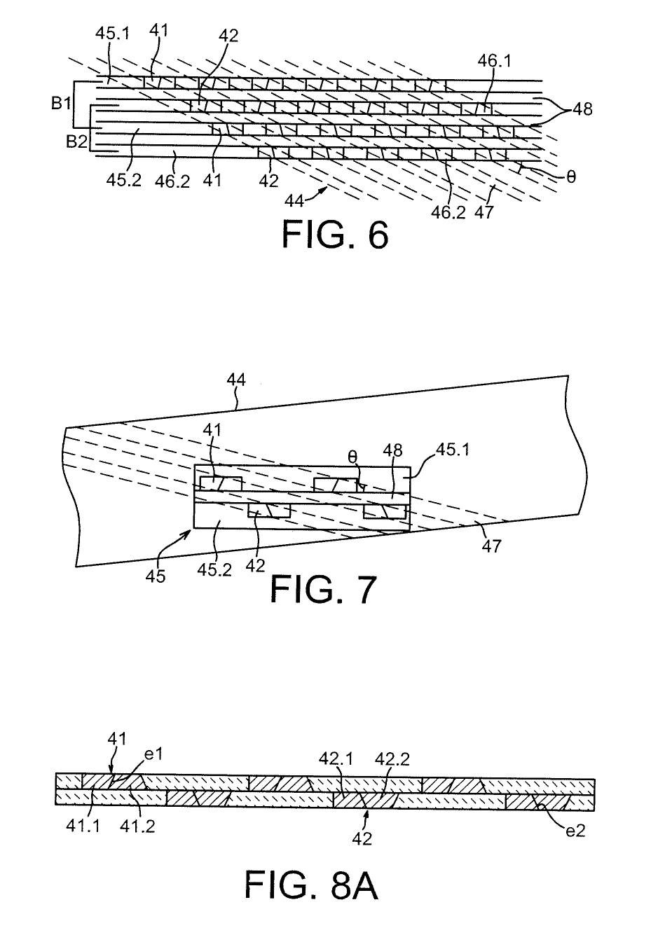

FIG. 6 shows another variant in which the supports 45.1, 45.2, 46.1, 46.2 are always superposed but in this case the supports 45.1, 45.2 or 46.1, 46.2 of a block B1 or B2 are no longer adjacent. In the stack, the supports 45.1, 45.2 of a block B1 and the supports 46.1, 46.2 of the other block B2 are alternating. The azimuth angles of magnetic heads for which pairs of polar parts are placed on adjacent supports 45.1, 46.1 are identical. These magnetic heads belong to different blocks B1, B2. The azimuth angles of magnetic heads for which the pairs of polar parts are on supports belonging to a particular block are different. The supports 45.1, 46.1, 45.2, 46.2 are separated by an inter-support layer 48. In this example, each of these layers may advantageously comprise magnetic shielding.

FIG. 6 shows a WRWR stack of write, read, write, read heads made starting from the top.

The recording and/or read device according to the invention is not limited to operating with a magnetic recording medium on which recording is done linearly as shown on the figures that have just been described.

Such a recording and/or read device may also be applied to amagnetic medium on which recording is done helically as shown in FIG. 7. For example, this is a device with quadruple magnetic heads, dedicated to recording and/or reading. The different elements shown in this figure have the same references as in FIGS. 5 and 6 described above. It is assumed that references 45.1 and 45.2 are layers with different crystalline orientations. These two layers are separated by an electrically insulating layer 48. This recording and/or read device may be made by the assembly of two stacked supports as described above, but it may also be done on a common support 45, for example an SOI type support or more generally a support comprising an electrically insulating layer sandwiched between two monocrystalline layers.

The different magnetic recording tracks reference 47 are now tilted from the general direction of the magnetic recording medium 44 (in this case of the helical type). These tracks 47 are parallel to the general direction of the magnetic recording medium 44 (linear type) in FIGS. 4 to 6.

The inter-support layer 33, 34, 48 may be composed of an insulator, for example silicon oxide (SiO₂), silicon nitride (Si₃N₄), alumina (Al₂O₃), zirconia (ZrO₂), silicon carbide (SiC), AlSiC (mix of alumina and silicon carbide), titanium carbide (TiC), AlTiC (mix of alumina and titanium carbide) or any other insulator with good resistance to wear. This layer can be made in one or several steps, for example by a deposition method using microelectronics equipment or micro on nanotechnology equipment, for example such as cathodic sputtering (PVD, PECVD, etc.). If the insulating layer of an SOI/XOI substrate is used as the inter-support layer, its thickness shall be adjusted by the substrate manufacturer by any method used in this type of industry. To make it easy to assemble the supports 1001 and 1002 in FIG. 3, on each side of the inter-support layer 33, 34, the inter-support layer can be made on either one or both of the supports 1001, 1002 avec for example using mechanical-chemical levelling steps and appropriate surface preparations so that assembly can be made later with precise positioning. The inter-support distance d will then obviously be the sum of the thicknesses deposited on each support 1001 and 1002. Each of these thicknesses may possibly contain one or several magnetic shields and/or magnetoresistive elements (GMR or more generally XMR) buried in the insulator 33, 34 (deposited and/or etched by appropriate micro-technological equipment).

We will now describe example embodiments of a recording and/or read device according to the invention. The magnetic heads are made collectively, pairs of polar parts are distributed on several supports. The sections in figures containing sections are taken at pairs of polar parts. Magnetic heads are made on substrates and they correspond to the supports described above.

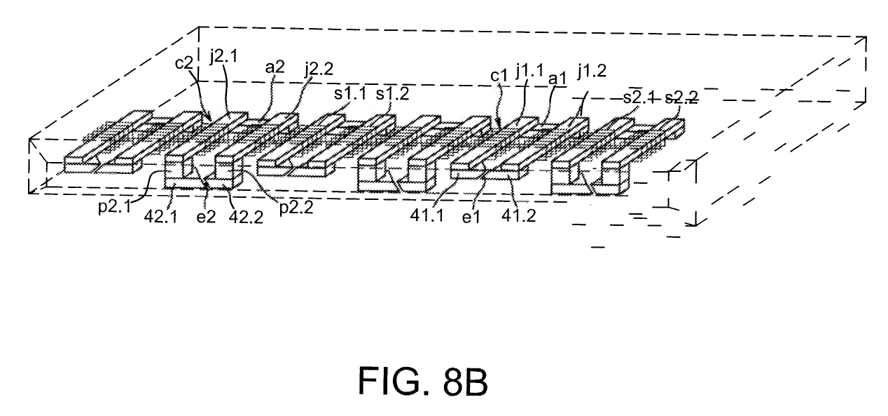

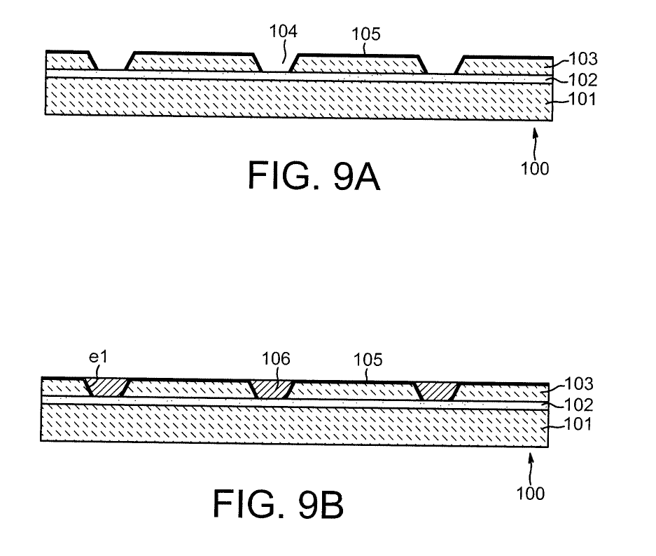

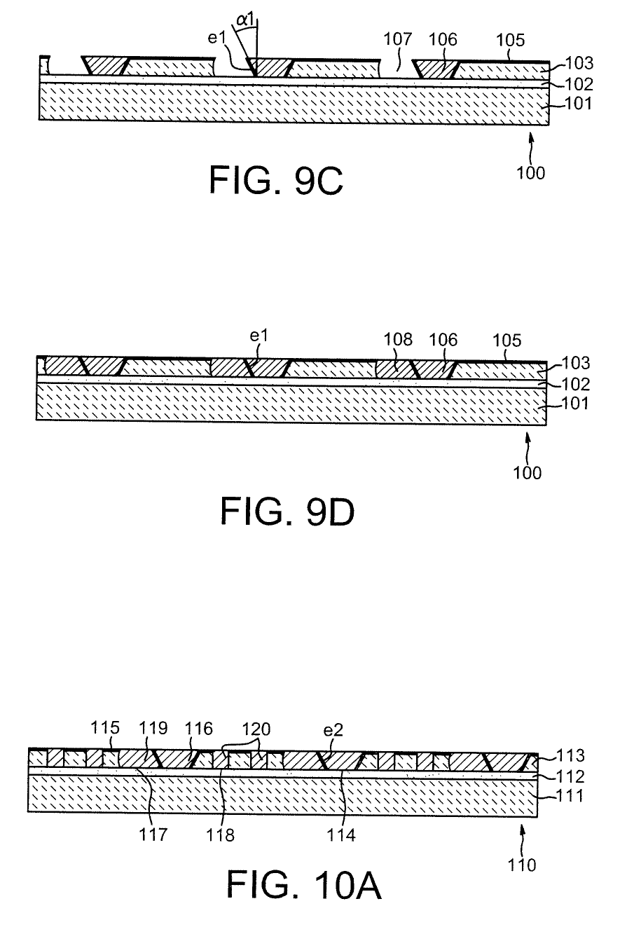

Refer to FIGS. 9A to 9D that describe a first embodiment of a recording and/or read device similar to that shown in FIGS. 8A and 8B. In FIG. 8A, the magnetic heads are shown in a side view, all that can be seen for each is the functional face of its pair 41, 42 of polar parts separated by the head gap e1, e2. This is the face that will fly over the magnetic recording medium (not shown).

In the examples, the recording and/or read device comprises two supports, each carrying three magnetic heads. In a real device, there will be many more magnetic heads, for example of the order of several hundred, distributed in strips one behind the other in a two-dimensional matrix arrangement, for example on round or square wafers.

The view in FIG. 8B is in three dimensions and the magnetic circuit can be seen for each magnetic head with a magnetic flux guide c1, c2 that connects two polar parts 41.1, 41.2, 42.1, 42.2 of a head 41, 42. This magnetic flux guide c1, c2 may comprise two legs j1.1, j1.2, j2.1, j2.2 magnetically connected firstly to a polar part 41.1, 41.2, 42.1, 42.2 and secondly to a single rear magnetic closing part a1, a2. The connection between the legs j1.1, j1.2, j2.1, j2.2 and the polar parts 41.1, 41.2, 42.1, 42.2 may be made directly or through magnetic connection pads p2.1, p2.2, depending on the support on which the polar parts of the magnetic head are located.

As a variant, the magnetic circuit could be a monolithic magnetic circuit, approximately in the shape of a horseshoe or similar, each end of which is formed by a polar part.

FIG. 8B also shows recording and/or read means in the form of solenoid windings s1.1, s1.2, s2.1, s2.2 cooperating with the legs j1.1, j1.2, j2.1, j2.2 of flux guides c1, c2.

Refer to FIG. 9A. The starting point is a first substrate 100 with an electrically insulating layer 102 sandwiched between two external layers 101, 103, at least one 103 of which is made from a monocrystalline material.

It could be a semiconductor on insulator type substrate, for example an SOI type (silicon on insulator) type substrate. Note that such a substrate is composed of an electrically insulating layer 102 sandwiched between two semi-conducting layers 101, 103. In general, one of the semiconducting layers is thicker than the other. Such a semiconducting on insulator substrate is not essential.

Advantageously, the other external layer 101 could be made in a material resistant to wear, this material possibly being neither semiconducting nor monocrystalline. It could for example be made from zirconia ZrO₂, silicon carbide and alumina AlSiC, titanium carbide and alumina AlTiC, alumina Al₂O₃ or other. This external layer 101 is advantageously thicker than the monocrystalline layer.

The fact that one of the external layers is monocrystalline will be used to make etchings that control the azimuth angle of the head gaps. Therefore, its crystallographic orientation will be chosen as a function of the required azimuth angle.

The first flared caissons 104 that will hold one of the polar parts in each pair of polar parts to be located on this first substrate will be etched in the external monocrystalline layer 103 (FIG. 9A). For example, in the case of silicon, this etching will consist of a wet anisotropic chemical etching, for example in a potassium bath KOH. The inclination of one of the sides of each first caisson controls the value of the azimuth angle. This inclination takes advantage of the monocrystalline nature of the substrate, the anisotropic etching following a crystallographic plane of the substrate. In silicon, the planes in the <111> family limit the etching edges. These substrates are available off-the-shelf. For example, this method is described in document FR-A1-2 664 729.

The layer of electrically insulating material 102 of the substrate 100 is used as a stop layer while etching the first caissons 104. The thickness of the monocrystalline layer 103 of the substrate 100 controls the width of the polar parts of pairs located on this first substrate. Its thickness is chosen accordingly.

A layer 105 of amagnetic material is formed on the first substrate 100, and it coats the sides of the first caissons 104 with an approximately uniform thickness. A surface thermal oxidation of the first substrate 100 thus worked can be made (FIG. 9A) if the first caissons are made from silicon. As a variant, the required thickness of the amagnetic material could also have been deposited on the sides of the first caissons.

The layer 105 of amagnetic material, for example made from silicon oxide, that coats one of the flared sides of each of the first caissons 104 will form the azimuth-controlled head gap e1 of each of the first pairs of polar parts located on the substrate 100.

A magnetic material 106 is deposited in the first caissons 104, for example by electrolysis. The magnetic material may or may not be laminated, for example it may be an alloy of NiFe, CoFe or CoFeX, where X represents an appropriate material such as Cr, Cu or other.

The surface of the substrate 100 thus worked is leveled such that the oxide is flush with the surface and the magnetic material has the required thickness (FIG. 9B). This magnetic material forms a first polar part 106 of each first pair of polar parts.

The next step is to isotropically etch second caissons 107 that will hold the other polar part in each first pair of polar parts that will be located on the first substrate 100 (FIG. 9C). These second caissons 107 are contiguous with the first caissons 104 and are all located on the same side of these first caissons 104. In the example, they are to the left of the first caissons 104. They could be to the right. The azimuth angle would then be different, it would be in another plane of the <111> family. The monocrystalline material in the external layer 103 that is close to the head gap is removed by etching. The amagnetic material in the head gap e1 is used as a side for these second caissons 107. The depth of these second caissons is approximately the same as the depth of the first caissons because the insulating layer 102 is used as a stop layer.

These second caissons 107 are filled with a magnetic material 108, for example by electrolysis, and the final step is a levelling step as described above (FIG. 9D). This magnetic material 108 forms a second polar part of each first pair of polar parts. This levelling step helps with the final adjustment of the width of polar parts. It gives very good alignment on the upper face of pairs of polar parts (upper face in the figure).

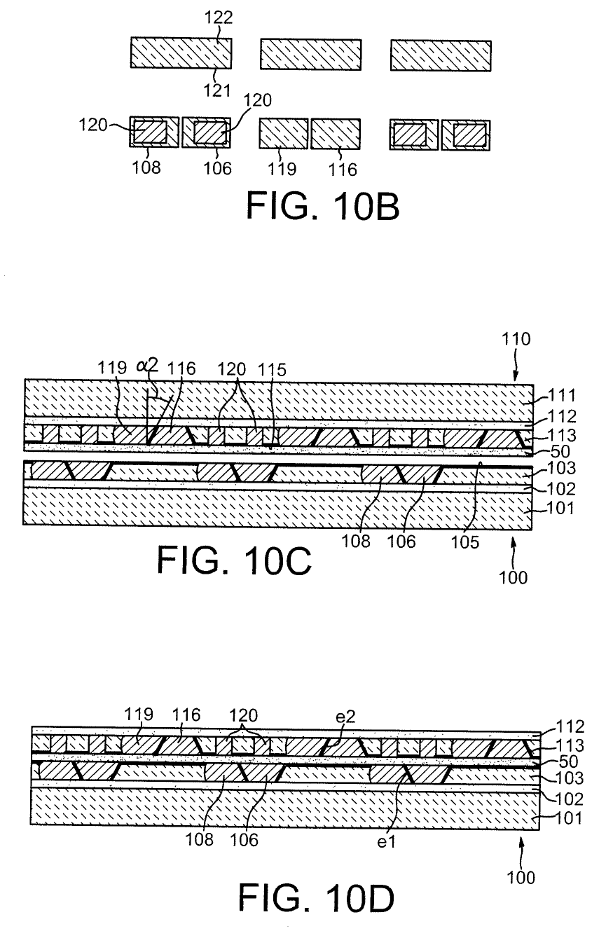

Refer to FIG. 10A. Starting from a second substrate 110 comprising an insulating layer 112 buried between two external layers 111, 113, at least one 113 of which is monocrystalline (for example an SOI substrate). Explanations about the choice of the first substrate and the thickness of its monocrystalline layer are applicable for the second substrate.

Second pairs of polar parts will be made that will be located on the second substrate 110. The first caissons 114 are made in the monocrystalline layer 113 by anisotropic etching and are filled with a magnetic material 116, including a step for formation of an amagnetic layer 115, for example by surface thermal oxidation in the case of first caissons 114 formed in the silicon, before filling and levelling as described in FIGS. 9A and 9B. The portion of amagnetic material 115 on one of the flared sides of the first caissons 114 will form the head gap e2 of the second pairs of polar parts.

The second caissons 117 are made by isotropic etching as described in FIG. 9C. The second caissons 117 are adjacent to the first caissons 114 and in this example are all adjacent on the same side of these first caissons 114, to the left as in FIG. 9C. They could be to the right, this depends particularly on the final azimuth angle of the pairs of polar parts located on the second substrate. The position of the second caissons 117 depends particularly on the relative movement to be made when one of the substrate is turned over with respect to the other at the time of their assembly. The sign of the azimuth angle can thus change during the subsequent step in which the first substrate is assembled to the second substrate depending on the type of turning used.

Pairs of third caissons 118 designed to hold pairs of magnetic connection pads 120 each of which will magnetically connect a polar part of a first pair of polar parts located on the first substrate to the magnetic circuit to be finalised later, are made for example at the same time as the second caissons 117, between groups of first and second caissons 114, 117. These third caissons 118 are positioned such that the magnetic pads of one pair are magnetically connected to the polar parts 108, 106 of a first pair of polar parts when the first substrate 100 and the second substrate 110 are aligned and assembled to each other after turning one of the two over. A 180° flip about an axis transverse to the substrate could be introduced such that the required azimuth angles on the two substrates are obtained.

Fourth rear caissons 121 designed to hold rear magnetic closing parts 122 can also be made at the same stage or at the same time as the second and third caissons 117 and 118, also by isotropic etching of the monocrystalline layer 113 of the second substrate 110, each of these rear magnetic closing parts being part of the flux guide of a magnetic head of the recording and/or read device. These fourth caissons 121 are placed such that the rear magnetic closing parts 122 are facing the first and second pairs of polar parts. Therefore, they can advantageously be made at the same level as the second pairs of polar parts.

Refer to FIG. 10B that shows a partial top view of pairs of magnetic pads 120 and rear magnetic closing parts 122. In FIG. 10B, it is assumed that first and second substrates (not visible) have been assembled and positioned in an appropriate manner.

Producing these fourth caissons 121 is particularly important when the magnetic circuit comprises a flux guide with two magnetic legs and a rear magnetic closing part. This step is superfluous when the magnetic circuit is monolithic.

These second caissons 117, third caissons 118 and fourth caissons 121 are filled with amagnetic material as described with reference to FIG. 9D and surface levelling is done. The magnetic material will form second polar parts 119 of the second pairs of polar parts and the connection pads 120.

The azimuth angle of the head gaps e1, e2 of the first and second pairs of polar parts was adjusted in the required manner due to the choice of the crystallographic orientation of monocrystalline layers 103, 113. These azimuth angles may be opposite if it is required that these should be opposite in the final state after assembly of the substrates. The width of polar parts, that are not necessarily equal in different substrates, was adjusted as required.

The next step is to position and assemble the first substrate 100 and the second substrate 110 by their worked faces, after turning one of the two over and possibly making a 180° flip of one of the substrates about a transverse axis of said substrate. Care is taken during positioning to align each magnetic pad 120 with a polar part 108, 109 of the first substrate. For example, this alignment can be done by infrared sighting or under X-rays.

The assembly can be made by any technique known to a person skilled in the art of micro-technologies and particularly micro-electromechanical systems (MEMS).

Advantageous assembly methods include bonding by glue, anodic bonding, direct bonding as described in document FR-A-2 774 797 or flip chip bonding. Preparation of surfaces to be assembled, possibly including mechanical-chemical levelling, may be necessary depending on the selected assembly type. This levelling will be done particularly in the case of direct bonding.

FIG. 10C illustrates the two substrates 100, 110 just before being assembled. It can be seen that leveled oxide 105, 115 remains partially on the surface, contributing to direct bonding. This oxide only remains between caissons filled with a magnetic material.

Before assembly, it is advantageous to deposit an insulating layer 50 (for example silicon oxide) and/or a magnetic shielding layer on the surface of at least one of the substrates 100, 110, so as to adjust the inter-polar part distance d. The insulating layer 50 could advantageously be made from a wear resistant material so as to limit wear of the recording and/or read device. Its choice could also facilitate the assembly of substrates.

Openings could also be left in the shielding layer at the magnetic pads 120, regardless of whether the shielding layer is located on one or the other of the substrates or on both.

Turning one of the substrates 100 or 110 over can change the sign of the azimuth angle of the pairs of polar parts located on this substrate. This depends on the method of working. If the substrate is turned over and rotated by 180° about a transverse axis at the same time, the sign will be changed.

The unworked layer 111 of the second substrate 110 can then be eliminated. This elimination can be done selectively, for example by chemical etching for example using potassium hydroxide KOH, or by mechanical-chemical attack stopping on the buried insulating layer 112 (FIG. 10D). If necessary, the buried insulating layer 112 can be thinned to make the second pairs of polar parts 116, 119 and the pairs of magnetic pads 120 appear or almost appear.

The remainder of the flux guide of each of the magnetic heads will now be made, in other words in this example the magnetic legs, and the recording and/or read means. If the rear closing magnetic parts in FIG. 10A are not made, the flux guide will be shaped approximately like a horseshoe. The method used is based on the method described in patent application FR-A-2 745 111.

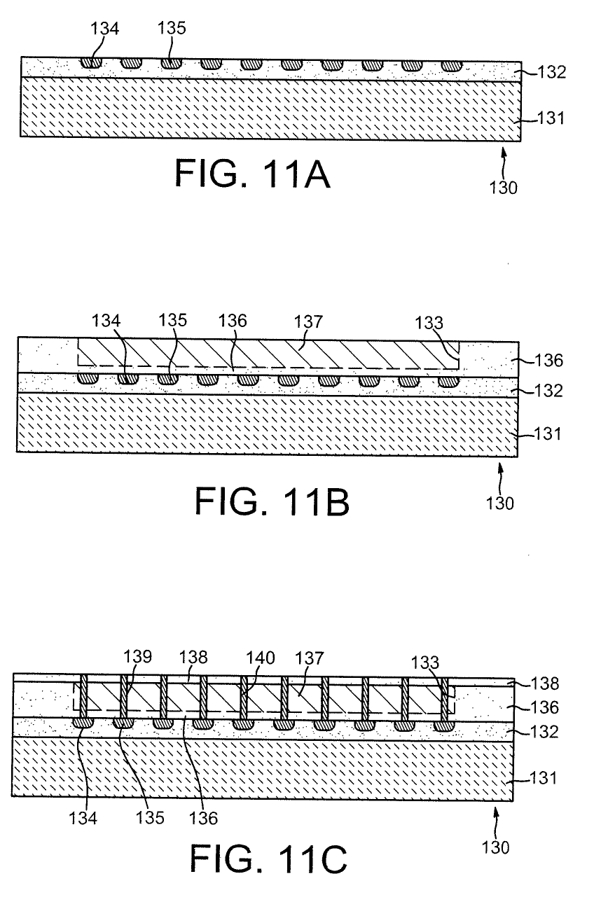

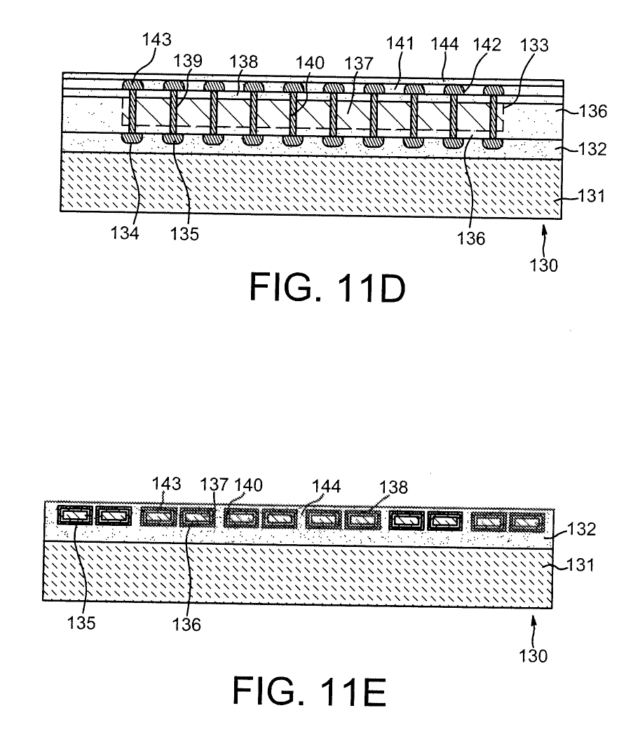

Remember that in this example, the recording and/or read means are solenoid type windings that surround the magnetic circuit at the legs or branches of the horseshoe. Refer to FIGS. 11A to 11E. FIGS. 11A to 11D are sections along a leg of the magnetic circuit.

There is a third substrate 130 with a base layer 131 (for example a semiconducting layer) covered by a layer of electrically insulating material 132. A bulk substrate or a wear resistant material possibly covered by an insulating material could very well be used for the layer 131. The first step will be to form a first layer of conductors for each solenoid that will extend between a polar part and a rear magnetic closing part or along a branch of the horseshoe shape magnetic circuit.

This is done by forming first parallel grooves 134 approximately perpendicular to the axis of the magnetic cores of the solenoids, in the insulating layer 132 at the locations at which the solenoids are to be located. These cores correspond to the legs j1.1, j1.2, j2.1, j2.2 shown in FIG. 8B.

These first grooves 134 are filled in by depositing a conducting material 135, based on copper, for example by electrolysis (FIG. 11A). This conducting material 135 forms conducting portions in the first layer of conductors.

The next step is levelling, for example mechanical or preferably mechanical-chemical to eliminate the superfluous conducting material 135 above the grooves 134.

An electrically insulating layer 136 for example made from silicon oxide is deposited, for example by PECVD, over the entire leveled surface, thickness greater than the required thickness for the legs. The insulating layer 136 is etched so that caissons 133 appear at the legs of the magnetic circuit to be made. The thickness of the bottom of these caissons 133 is sufficient to electrically insulate conductors in the first layer of conductors from the magnetic circuit. A magnetic material 137, possibly laminated as described above, is deposited in these caissons 133 to make polar parts (FIG. 11B). The surface obtained is leveled as described above.

We will now make the lateral conductors of the solenoids. An electrically insulating layer 138 is deposited on the leveled surface (for example silicon oxide by PECVD). The sinks 139 are etched in the insulating layers 138 and 136 until the ends of the conductors 135 in the first layer of conductors are reached. These sinks 139 are filled with conducting material 140, for example a copper-based material, for example by electrolysis (FIG. 11C). The surface obtained is leveled. This conducting material forms the lateral conductors 140 of the solenoids.

The next step shown in FIG. 11D is to make a second horizontal layer (on the figure) of solenoid conductors by depositing a layer of electrically insulating material 141 on the surface of the structure obtained, by etching second grooves 142 in this material, the ends of which expose the lateral conductors 140 thus made. The second grooves are not quite parallel to the first grooves 134, one of their ends is offset by a distance so as to make the solenoid. The second grooves 142 are filled with conducting copper-based material 143, for example deposited by electrolysis. The surface obtained is leveled. The conducting material 143 forms conductors in the second layer of solenoid conductors. The conducting material 143 is covered by a layer of electrically insulating material 144. It is planned to make the contact at the ends of the solenoid conductor (not visible).

The caissons 133 in FIGS. 11C and 11D are shown in dashed lines, to show that they are not in the same section plane as the sinks 139. These sinks are actually <<in front of>> the caissons 133, they do not pass through the magnetic material 137 that fills in the caissons but they do pass through the material in the insulating layer 136. The grooves 134 are not quite perpendicular to the axis of the caissons 133.

FIG. 11E illustrates the configuration of the third substrate 130 just before being assembled to the structure formed from the first substrate 100 and the second substrate 110, at a scale different from the scale in figure 11D and in a side view of this figure.

The third substrate may possibly hold signal processing means processing signals output or acquired by the magnetic heads.

The third substrate 130 and the structure shown in FIG. 10D are positioned with alignment, and are assembled after turning one of the two over. The assembly may be made using one of the methods described above.

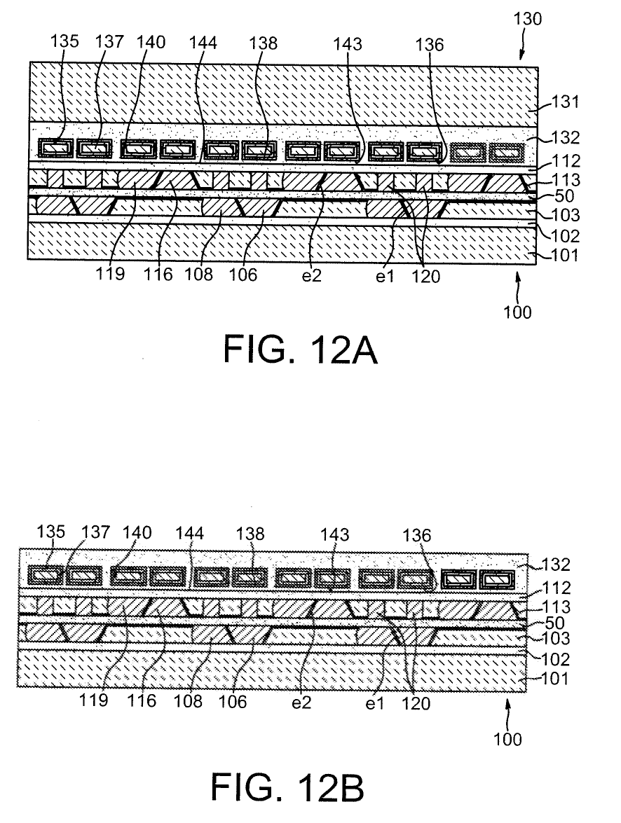

In FIG. 12A, the third substrate 130 was assembled by direct or other bonding, with alignment such that each magnetic circuit 137 is magnetically connected to a pair of polar parts 106, 108, 116, 119, this connection either being made directly or indirectly through magnetic pads 120. The only remaining step is possibly to totally or partially eliminate the base layer 131 of the third substrate 130 (FIG. 12B), for example by complete or local selective etching of the material in this base layer 131 stopping on the insulating layer 132. Contact can then be made through the insulating material of the layer 132 for providing power supply or detecting the signal from the recording and/or read means (the solenoids formed by 135, 140, 143 in this particular case).

It may be useful to keep the unworked layer 101 of the first substrate 100, in this case it can advantageously be made from a wear resistant material, for example made from AlTiC, ZrO₂, AlSiC.

Instead of making the remainder of the flux guide for each of the magnetic heads and the recording and/or read means on a specific substrate, it would have been possible to make them on the assembly described in FIG. 10D following the steps described in FIGS. 11A to 11E or on at least one of the first and second substrates 100, 110. A structure obtained in this way would be similar to the structure shown in FIG. 12B. It is then superfluous to show the different steps leading to such a structure, all that is necessary is to refer to the description in FIGS. 11A to 11E with the only difference that the electrically insulating layer 132 will be deposited on the electrically insulating layer 112 of the stack described in FIG. 10D.

The next step is treatment of the structure obtained in FIG. 12B so as to make the substrates have a given tilt angle θ from the magnetic tracks of the magnetic recording medium.

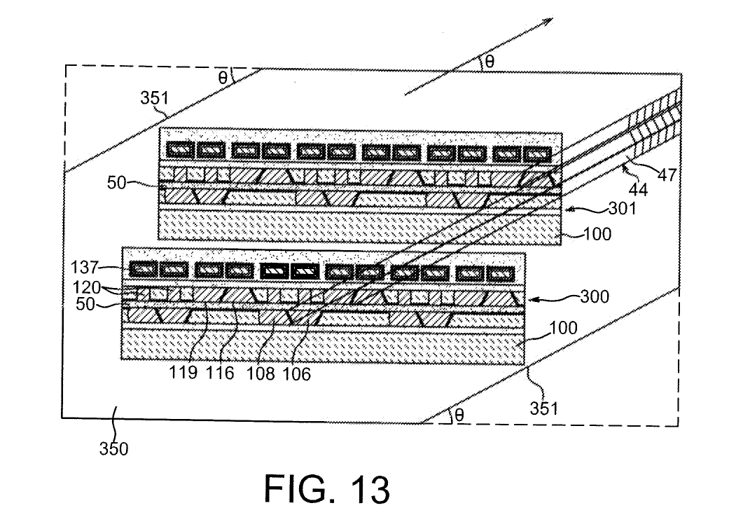

This treatment may consist of integrating one or several blocks (strips or chips) of magnetic heads on a common mechanical support. Thus the mechanical support encompasses particularly strips, chips, etc. Refer to FIG. 13. Firstly, the magnetic heads are tested and the structure in FIG. 12B is cut into blocks (strips or chips) 300, 301. As described above, several hundred magnetic heads are made collectively. One or several of these blocks 300, 301 is mounted on a given mechanical support 350. This step is known under the term <<back-end>> or <<packaging>>. The mechanical support 350 will advantageously be made from a wear resistant material for example AlTiC (titanium carbide and alumina) that is currently used by manufacturers of linear magnetic heads.

The next step is to grind the contour of the mechanical support 350, for example at its faces 351 such that substrates 100, 110 can have a required tilt angle θ with respect to the tracks 47 of the magnetic recording medium 44.

Obviously, the mechanical support is not necessary. The structure shown in FIG. 12A could be ground directly before or after cutting into chips so as to create the tilt angle θ, particularly if it is small, on the external faces of substrates 100 and 110. In this case, the electrical contacts will advantageously be made by local etching.

A second embodiment of a recording and/or read device according to the invention will be described. There are no pairs of magnetic connection pads in this configuration.

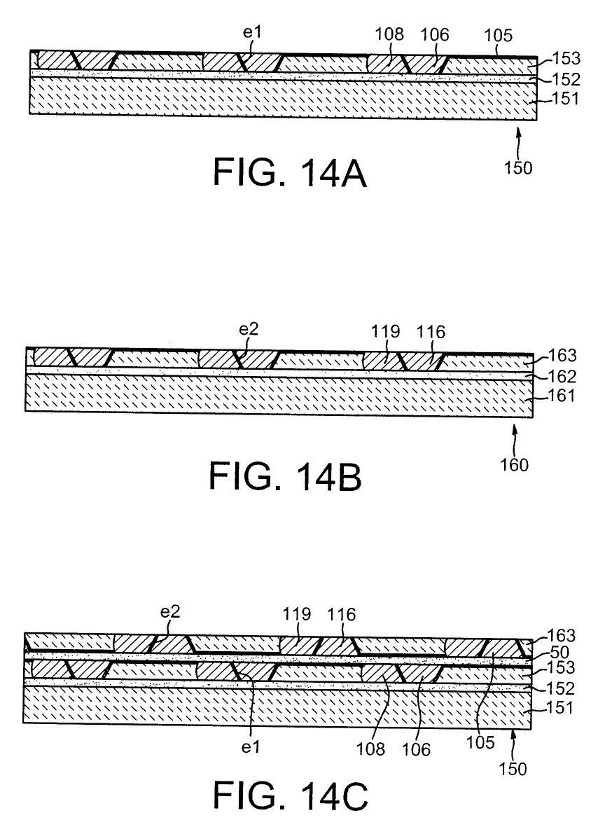

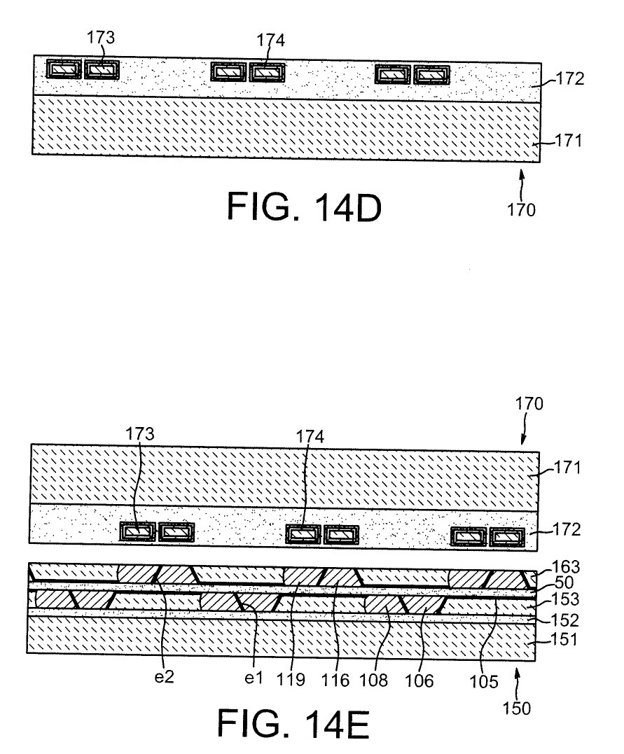

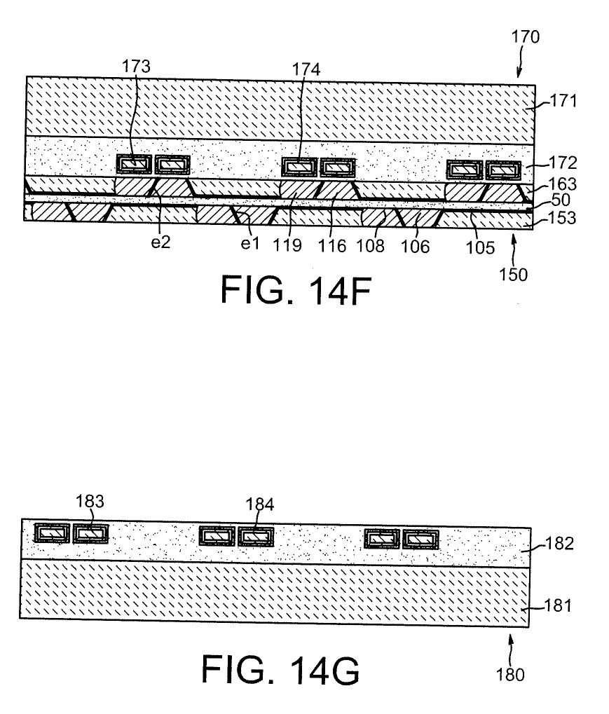

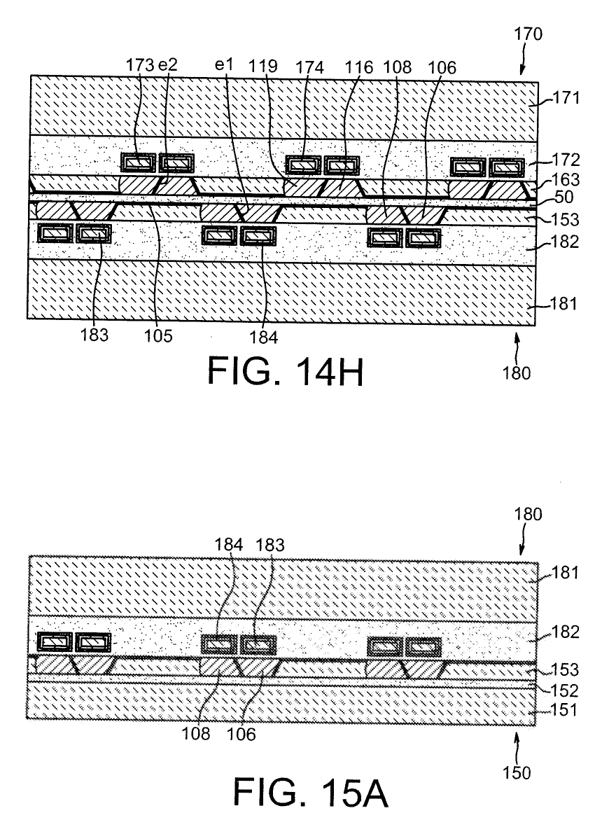

The procedure described in FIGS. 9A to 9D is followed to make first pairs of polar parts 106, 108 on a first substrate 150 (formed from a stack with a first electrically insulating layer 152 sandwiched for example between two external layers, for example semiconducting layers 151, 153, at least one of which is monocrystalline (see FIG. 14A)). The substrate 150 may be of the SOI type. Rear magnetic closing parts could possibly be made as described in FIGS. 10A, 10B.

The procedure described in FIGS. 9A to 9D is followed to make second pairs of polar parts 116, 119 (on a second substrate 160 (formed from a stack with a first electrically insulating layer 162 sandwiched for example between two external layers, for example semiconducting layers 161, 163, at least one of which is monocrystalline (see FIG. 14A). The second substrate 160 may be of the SOI type. Magnetic pads are not made. Rear magnetic closing parts could possibly be made as described in FIGS. 10A, 10B.

The first substrate 150 and the second substrate 160 are positioned and assembled by their worked faces, after turning one of the two over, taking care during positioning to align them by placing the first pairs of polar parts 106, 108 and the second pairs of polar parts 116, 119 alternately longitudinally (FIG. 14C). Assembly and alignment can be done as described previously in FIG. 10C. An insulating layer 50 can be made between the two substrates possibly containing a magnetic shielding screen. It is deposited on at least one of the substrates.

The intact external layer 161 and the buried (at least partly) electrically insulating layer 162 can be eliminated from one of the substrates 160 for example the second substrate (FIG. 14C). For example, the external layer 161 can be eliminated by chemical etching (for example using potassium hydroxide KOH) or mechanical-chemical etching, and the buried insulating layer 162 can for example be eliminated by ionic machining or other dry etching.

A thin insulating layer may remain, and its moderate thickness will enable magnetic continuity. This electrically insulating layer is even particularly advantageous in some cases because it enables magnetic decoupling between the different elements and reduces effects due to eddy currents.

Refer to FIG. 14D. First magnetic circuit flux guides 173 and first recording and/or read means 174, for example of the solenoid type as described in FIGS. 11A to 11E, are made on a third substrate 170 (formed of a base layer 171 for example a semiconducting and/or wear resistant layer covered by an electrically insulating layer 172), these first flux guides 173 and these first recording and/or read means 174 being designed to cooperate with first pairs of polar parts or with second pairs of polar parts. The example described relates to second pairs of polar parts 116, 119. Therefore this third substrate 170 is provided with fewer flux guides than the previous embodiment.

In FIG. 14E, the third substrate 170 is positioned and assembled with the structure shown in FIG. 14C after turning one of the two over, taking care to make them aligned. This assembly may be done as described in FIG. 12A.

The first flux guides 173 placed on the third substrate 170 are then each magnetically connected to one of the second pairs of polar parts 116, 119 located on the second substrate 160.

Obviously, it is possible to manage without the third substrate, as was explained in the description of the previous embodiment. The flux guides and the recording and/or read means would be deposited directly on one of the worked substrates 150, 160. The two substrates can be assembled as shown in FIG. 14C after removal of the unworked support layers, advantageously using a superstrate.

The next step is to eliminate the unworked layer of material 151 and the buried insulating layer 152 (at least partially) of the first substrate 150. The layer 151 can be eliminated for example by chemical etching (for example with potassium hydroxide KOH) or mechano-chemical etching and the buried insulating layer 152 can be eliminated for example by ionic machining or other dry etching (FIG. 14F).

FIG. 14G shows second flux guides 183 and second recording and/or read means 184, for example of the solenoid type as described in FIGS. 11A to 11E, made on a fourth substrate 180 formed from a base layer 181 (for example semiconducting and/or wear resistant), covered by an electrically insulating layer 182, in the same way as on the third substrate. These second magnetic circuits 183 and these second recording and/or read means 184 will cooperate with other pairs of polar parts, in the example with first pairs of polar parts 106, 108.

In FIG. 14H, the fourth substrate 180 and the structure shown in FIG. 14F are positioned and assembled, after turning one of the two over. This positioning was done with alignment, for example as described in FIG. 12A. Each of the second magnetic circuits 183 placed on the fourth substrate 108 is then magnetically connected to one of the first pairs of polar parts 106, 108 located on the first substrate 150.

It would also be possible to reduce the thickness of the assembly, for example before integration onto a mechanical support 350 or for use without a complementary support, by thinning or by etching either or both of the base layers 171, 181 by a chemical, mechano-chemical or mechanical method, for example by grinding.

Electrical contacts (not shown) of the recording and/or read means can be made by using an intraconnection technology, or for example by local etching (dry or wet).

One or several chips of multiple magnetic heads can then be mounted on a mechanical support as described in FIG. 13. The mechanical support can then also be ground as described with reference to this FIG. 13.

We will now describe a third embodiment of a recording and/or read device according to the invention.

First pairs of polar parts 106, 108 and possibly rear magnetic parts are made on a first substrate 150, for example as described in FIGS. 9A to 9D, 10A and 11B. First flux guides 183 of magnetic circuits and first recording and/or read means 184 are then made on a second substrate 180, as for example described with reference to FIG. 14G.

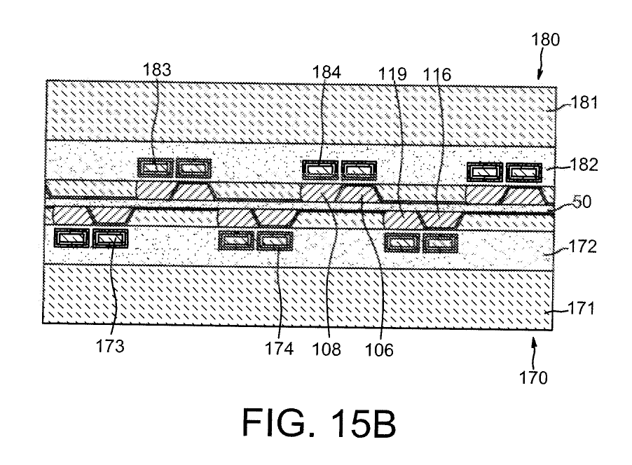

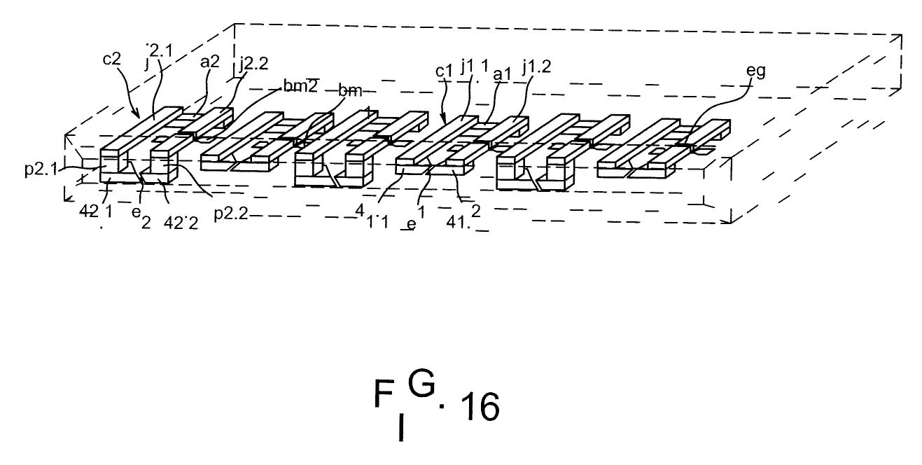

The first substrate 150 and the second substrate 180 are positioned and aligned and assembled after turning one of the two over, such that each first flux guide 183 is magnetically connected to one of the first pairs of polar parts 106, 108. Such a first structure is shown in FIG. 15A.

Similarly, second pairs of polar parts 116, 119 and possibly rear magnetic parts are then made on a third substrate 160, and second flux guides 173 and second recording and/or read means 174 are made on a fourth substrate 170, in the same way. The third substrate 160 and the fourth substrate 170 are positioned and aligned and assembled, after turning one of the two over so as to obtain a second structure similar to that shown in FIG. 15A.

The unworked layer 151, 161 and the layer of dielectric material 152, 162 are at least partially eliminated from the first substrate 150 and the third substrate 160.

The two structures are positioned and aligned and assembled, through their faces that have just been worked after turning one of the two over taking care to place the first pairs of polar parts and the second pairs of polar parts such that they are staggered (FIG. 15B). The assembly and alignment may be done as described above with reference to FIG. 10C. One of the unworked layers 170, 180 may be eliminated and/or the second layer may be partially eliminated for example by chemical etching.

Contacts (not shown) of the recording and/or read means can be made using an intra-connection technology, or for example by local etching (dry or wet).

The next step is the assembly of one or several chips of multiple magnetic heads on a given mechanical support as described in FIG. 13. Grinding is then done, as explained in the description of this FIG. 13.

We will now describe a method for making a read device according to the invention in which the read means are magneto-resistive. Refer to FIG. 16 that is similar to FIG. 8B, except that each magnetic circuit cooperates with a rod bm1, bm2 with giant magnetoresistance instead of a solenoid.

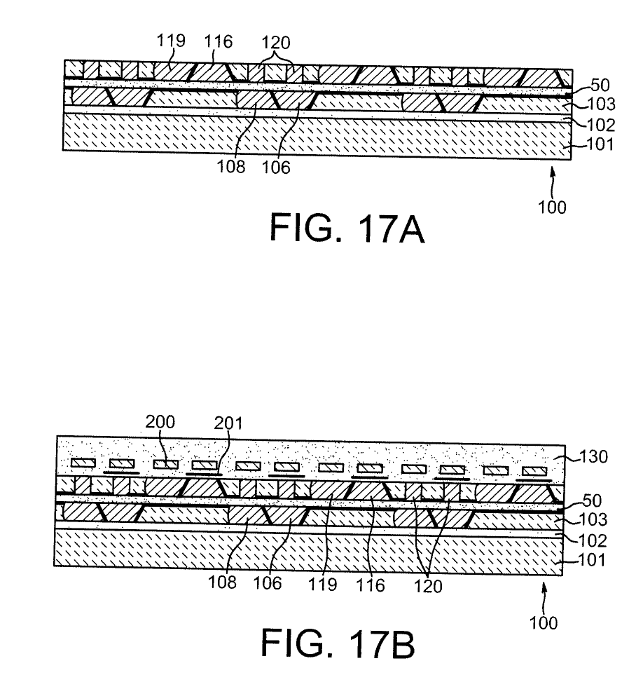

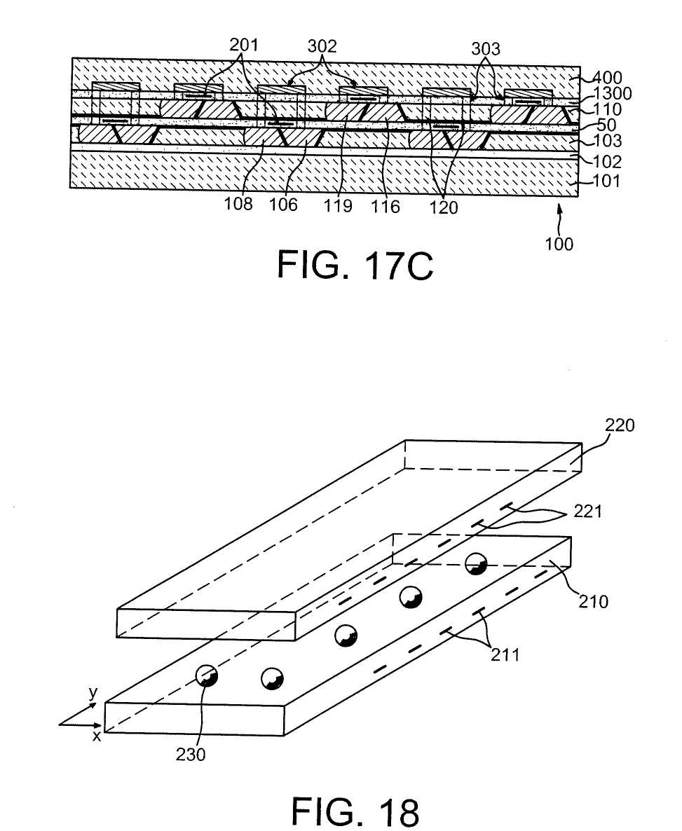

The starting point is a structure like that shown in FIG. 10D with first and second pairs of polar parts 106, 108, 116, 119 located on a first and second substrates 100, 110 respectively, these two substrates 100, 110 having been assembled to each other. Pairs of magnetic connection pads 120, and possibly rear magnetic closing parts (not shown) have also been made on one of the substrates 110 (FIG. 17A).

In much the same way as was described above with reference to FIG. 11, flux guides 200 of magnetic circuits can be made at least partially on a third support 130. A head gap eg can be provided for these flux guides at a leg j2.2, j1.2. The read means 201, formed of a rod for example with magnetoresistance, giant magnetoresistance (or possibly tunnel magnetoresistance with a slightly different method), are made for each of the magnetic circuits, by depositing an appropriate magnetoresistant layer on insulating material and then etching to a required contour, eliminating superfluous material and finally depositing an insulating layer. Each rod 201 is possibly close to a head gap (not shown in FIG. 17B but visible in FIG. 16) of a flux guide. The head gap is visible in FIG. 16.

As a variant, the flux guides 200 could be eliminated, the magnetoresistant rods 201 could be made to cooperate with pairs of polar parts to form complete magnetic circuits.

The third substrate 130 and the structure in FIG. 17A are positioned, aligned and assembled after turning one of the two over, so that each magnetic circuit is magnetically connected to a first pair of polar parts or to a second pair of polar parts.

The unworked layer 131 of the third substrate 130 is at least partially eliminated, for example by chemical or mechanical-chemical etching, so as to make contacts to supply power to the giant magnetoresistant rods 201.

In the same way as for the inductive recording and/or read means, it would also be possible to make the read means described above directly on the layer 103 of the first substrate 100 and/or the layer 113 of the second substrate 110, these then being buried in the layer 50 in FIG. 17A, without passing through a third substrate.

The next step would be assembly of one or several chips of multiple magnetic heads (one or several parts of assembled substrates) on a same mechanical support as described in FIG. 13. Grinding could then be done as described during the description of this FIG. 13.

Obviously, it would be possible to make a read device with magnetoresistance according to one of the variants described above for an inductive recording and/or read device.

FIG. 17C shows a sectional view of another variant of a read device according to the invention. The read means are of the magneto-resistive type and are in the form of rods with magnetoresistance. They are referenced 201 and they are distributed in the layer 50 and in the layer 1300. There is no longer any need for pairs of magnetic connection pads because the magnetoresistant rods 201 in the layer 50 cooperate directly with pairs of polar parts 106, 108 in the first substrate 100, while magneto-resistant rods 201 in the layer 1300 cooperate directly with pairs of polar parts 116, 119 in the second substrate 110. Signal processing means 302, for example preamplifier, multiplexer and demultiplexer circuits cooperate with the read means 201. They are made on a substrate 400 that is above the stack, or in a layer made on the layer 1300 of this stack. They could be mounted on the surface of the stack on the layer 1300. They are positioned and aligned with the read means 201. They are electrically connected to the read means 201 through connection vias 303 that pass through the second substrate 110. A comparable structure would be obtained with signal processing means cooperating with recording means or recording and read means. These configurations are not shown to avoid unnecessarily increasing the number of figures, because they would add nothing.

All the above explanations are based on assemblies by gluing, direct bonding or anodic bonding but other methods of assembling substrates together could be used. One is assembly by flip chip bonding or ball bonding. FIG. 18 diagrammatically shows a recording and read device according to the invention in which a first substrate 210 carrying first pairs of polar parts 211 of magnetic heads will be assembled to a second substrate 220 carrying second pairs of polar parts 221 of magnetic heads by bumps 230 made from a fusible alloy.

This solution can give a very precise (submicronic) alignment in X-Y and can make electrical connections between different substrates. Patent application FR-A-2 807 546 describes this assembly method particularly for print heads and this is why no further details are given herein.

Although several embodiments of this invention have been represented and described in detail, it should be understood that different changes and modifications could be made to it without going outside the scope of the invention.

For example, steps in these methods can be combined with each other. It would be possible to envisage combining two or three of the described configurations in a single device according to the invention concerning the magnetic circuit and the recording and/or read means, namely a magnetoresistant rod cooperating with a pair of polar parts, a magnetoresistant rod cooperating with a flux guide, and a flux guide surrounded by a winding. Read heads and recording heads could be combined on the same substrate.

1-46. (canceled)

47: A device for recording on and/or reading from a magnetic medium with magnetic tracks, comprising:
plural magnetic heads each comprising a pair of polar parts separated by an amagnetic head gap with a given azimuth angle,
wherein the pairs of polar parts are distributed on fixed supports, the head gaps of the pairs of polar parts on a particular support all having the same azimuth angle, and
at least two supports comprise pairs of polar parts for which the head gaps have different azimuth angles, each support having a given tilt angle from the magnetic tracks.

48: A recording and/or read device according to claim 47, wherein all pairs of polar parts located on a particular support have the same width.

49: A recording and/or read device according to claim 47, wherein at least two supports have different tilt angles.

50: A recording and/or read device according to claim 47, wherein consecutive supports define an inter polar-part distance being the distance between planes of faces facing polar parts located on consecutive supports.

51: A recording and/or read device according to claim 50, wherein a magnetic shielding and/or magneto-resistive read means is placed in a space corresponding to the inter polar-part distance.

52: A recording and/or read device according to claim 50, wherein when two consecutive supports are parallel, the inter polar-part distance is given by d=[ tan(θ)·(T+D)]−(P1+P2) where θ is the tilt angle of supports relative to the tracks, T is the longitudinal pitch of head gaps of pairs of polar parts located on a particular support, D is the longitudinal offset from supports between two pairs of consecutive polar parts placed on two consecutive supports, P1 is the width of pairs of polar parts on a first support, and P2 is the width of polar parts on a second support consecutive to the first support.

53: A recording and/or read device according to claim 47, wherein two pairs of polar parts belonging to different supports cooperate with two consecutive magnetic tracks to read them or to record them.

54: A recording and/or read device according to claim 47, wherein following relation P1·cos(α1−θ)/cos=P2·cos(α2+θ)/cos(α2) is verified, where P1 is the width of pairs of polar parts on a first support, α1 is the azimuth angle of the head gaps of the pairs of polar parts on this first support, P2 is the width of polar parts on a second support, α2 is the azimuth angle of the head gaps of the pairs of polar parts on this second support, and θ is the tilt angle of supports from the magnetic tracks.

55: A recording and/or read device according to claim 54, wherein α1=2+2θ.

56: A recording and/or read device according to claim 54, wherein α1=−α2.

57: A recording and/or read device according to claim 47, wherein two consecutive supports form a common support, two series of pairs of polar parts being placed on each side of an electrically insulating layer in the common support.

58: A recording and/or read device according to claim 50, wherein two consecutive supports form a common support, two series of pairs of polar parts being placed on each side of an electrically insulating layer capable of precisely giving the distance of the inter-polar part.

59: A recording and/or read device according to claim 47, wherein the pairs of polar parts of a support belong to magnetic recording or read heads.

60: A recording and/or read device according to claim 47, comprising at least one block of supports for recording and at least one block of supports for reading, these blocks being arranged one after the other in the direction of the magnetic tracks.

61: A recording and/or read device according to claim 47, comprising at least one block of one or plural supports for recording and at least one block of one or plural supports for reading, the supports for these blocks being fixed to each other.

62: A recording and/or read device according to claim 60, wherein a block for reading is separated from a block for recording by a shielding screen.

63: A recording and/or read device according to claim 61, wherein the supports of a block for reading are alternated with the supports of a block for recording.

64: A recording and/or read device according to claim 61, wherein the magnetic shielding and/or magneto-resistive read means are contained in an inter-support layer placed in the space corresponding to the inter-polar part distance, this inter-support layer separating a support of a read block from a support of a recording block.

65: A recording and/or read device according to claim 47, comprising, for each magnetic head, a magnetic circuit integrating a pair of polar parts and optionally a magnetic flux guide, the magnetic circuit cooperating with recording and/or read means.

66: A recording and/or read device according to claim 65, wherein the recording and/or read means and the magnetic flux guide, if any, for each magnetic head are on an additional support assembled to the support of the pairs of polar parts of the magnetic head.

67: A recording and/or read device according to claim 65, wherein the recording and/or read means are inductive or magnetoresistive.

68: A recording and/or read device according to claim 47, wherein signal processing means cooperates with recording and/or read means.

69: A method for making a record and/or read device on a magnetic medium with magnetic tracks, comprising:
on a first substrate, manufacturing plural first pairs of polar parts of first magnetic heads, these polar parts being separated by an amagnetic head gap with a particular first azimuth angle;
on a second substrate, manufacturing plural second pairs of polar parts of second magnetic heads, these polar parts being separated by an amagnetic head gap with a particular second azimuth angle;
assembling the first substrate to the second substrate positioning them such that the first azimuth angle and the second azimuth angle are different after assembly;
manufacturing at least one of recording and/or read means and optionally magnetic flux guides configured to each cooperate with a pair of polar parts of the first pairs of polar parts and/or second pairs of polar parts;
treating the substrates to provide the substrates with a given tilt angle relative to the magnetic tracks.

70: A method according to claim 69, wherein the first and the second substrates may be assembled before or after the treatment.

71: A method according to claim 69, further comprising inserting a layer of an electrically insulating material between the two substrates.

72: A method according to claim 69, further comprising inserting shims made from an electrically insulating material between the two substrates.

73: A method according to claim 69, wherein the recording and/or read means and magnetic flux guides, if any, are made on at least a third substrate that is positioned and assembled with the first substrate and/or the second substrate.

74: A method according to claim 73, wherein the first substrate is assembled to a first third substrate after turning one of the two over, the second substrate is assembled to another third substrate after turning one of the two over, and the first substrate is assembled to the second substrate.

75: A method according to claim 69, wherein the recording and/or read means and magnetic flux guides, if any, are made on either the first or the second substrate or both.

76: A method according to claim 69, wherein the treatment grinds the substrates before or after assembly.

77: A method according to claim 69, wherein the treatment assembles the substrates or one or plural parts of the substrates in a particular mechanical support.

78: A method according to claim 69, wherein the tilt angle of the first substrate is different from the tilt angle of the second substrate.

79: A method according to claim 69, further comprising making pairs of magnetic connection pads in the second substrate configured to magnetically connect each of the recording and/or read means or a flux guide to a pair of polar parts in the first substrate.

80: A method according to claim 73, wherein when there are two third substrates, the pairs of polar parts in the first substrate are coupled to recording and/or read means or a flux guide in one of the third substrates, the pairs of polar parts in the second substrate are coupled to recording and/or read means or a flux guide in the other third substrate.

81: A method according to claim 69, wherein the first and second substrates are assembled to each other after turning one of the two over.

82: A method according to claim 69, further comprising thinning at least one of the substrates before and/or after assembly.

83: A method according to claim 69, wherein positioning is done with alignment of the substrates.

84: A method according to claim 69, wherein a first or second pair of polar parts is obtained by making a first caisson by anisotropic etching in the first or the second substrate, to form an amagnetic layer on the first or the second substrate, the first caisson is filled with a magnetic material, and a second caisson adjacent to the first caisson is made by isotropic etching, and the second caisson is filled with a magnetic material.

85: A method according to claim 79, wherein a pair of magnetic pads is obtained by isotropically etching a pair of caissons in the second substrate, between two pairs of polar parts in the second substrate, and the pair of caissons is filled with a magnetic material.

86: A method according to claim 85, wherein the surface is leveled after any one of the magnetic material filling steps has been done.

87: A method according to claim 69, wherein at least one of the first substrate or the second substrate is formed from an electrically insulating material located between two layers, one of the layers comprising the caissons being monocrystalline, the other layer configured to be eliminated later.

88: A method according to claim 69, wherein at least one of the first substrate or the second substrate is formed from an electrically insulating material located between a layer of wear resistant material and a layer of monocrystalline material comprising the caissons.

89: A method according to claim 69, wherein the assembly is made by gluing, direct bonding, anodic assembly, or by fusible bumps.

90: A method according to claim 73, wherein the third substrate within which the recording and/or read means and the magnetic flux guides, if any, are located is a multi-layer substrate with a layer of electrically insulating material.

91: A method according to claim 73, wherein the third substrate within which the recording and/or read means and the magnetic flux guides, if any, are located is a multi-layer substrate made from a wear resistant material layer covered by an electrically insulating material.

92: A method according to claim 73, further comprising making signal processing means that cooperate with the recording and/or read means.
